(19) United States
(12) Patent Application Publication
(10) Pub. No.: US 2005/0281534 A1
(43) Pub. Date: Dec. 22, 2005

(54) Method of film data comparison

(76) Inventor: John McKay, Wellington (NZ)

Correspondence Address: FOLEY & LARDNER LLP, 111 HUNTINGTON AVENUE, 26TH FLOOR, BOSTON, MA, 02199-7610, US

(21) Appl. No.: 11/156,165

(22) Filed: Jun. 17, 2005

Related U.S. Application Data
(63) Continuation of application No. PCT/NZ03/00285, filed on Dec. 22, 2003.

(30) Foreign Application Priority Data
Dec. 20, 2002 (NZ) 523296

(51) Int. Cl. H04N 5/76; G11B 27/00

(52) U.S. Cl. 386/52; 386/55

(57) ABSTRACT

The invention provides a method and system for film data comparison particularly but not solely designed to facilitate comparison of edit decision lists (EDS) in the film industry. In one form the invention provides a method of film data comparison comprising the steps of storing in computer memory two or more data files representing edit decision lists, comparing individual edits within the data files, categorising edits within the data files, and generating at least one change list based on the comparisons. The invention also provides a film data comparison system comprising a comparator configured to compare individual edits within data files representing edit decision lists, a category assignor configured to assign a category to one or more edits within the data files, and a generator configured to generate at least one change list based on the comparisons made by the comparator.

### FIELD OF INVENTION

The invention relates to a method of film data comparison particularly but not solely designed to facilitate comparison of edit decision lists (EDLs) in the film industry.

### BACKGROUND TO INVENTION

Production of a film typically commences with shooting a series of sequences of film on 35 mm or 16 mm film. Film editing has traditionally involved cutting and splicing pieces of this film together to form a finished product. Typically a film is transferred to another medium, for example a video tape and/or series of digital files, and this derivative representation is then manipulated until the desired result is achieved. As editing progresses, a list of every edit performed is generally maintained.

Alternatively, production of a film may commence directly onto a video tape. Subsequent editing of the video tape contents equivalent to cutting and splicing pieces of film are then performed on the video tape.

When the editing is completed and a final version of the picture is determined, a final list of events, called the edit decision list or EDL, is produced. The EDL is then used to cut and splice the original film. In most cases, the editor needs to compare the EDL to the final edited version of the picture in order to visually check accuracy. This comparison is a manually intensive and error-prone procedure.

### SUMMARY OF INVENTION

In broad terms in one form the invention comprises a method of film data comparison comprising the steps of storing in computer memory two or more data files representing edit decision lists; comparing individual edits within the data files; categorising edits within the data files; and generating at least one change list based on the comparisons.

In broad terms in another form the invention comprises a film data comparison system comprising a comparator configured to compare individual edits within data files representing edit decision lists; a category assignor configured to assign a category to one or more edits within the data files; and a generator configured to generate at least one change list based on the comparisons made by the comparator.

### BRIEF DESCRIPTION OF THE FIGURES

Preferred forms of the invention are now described with reference to the accompanying figures in which:

FIG. 1 illustrates a preferred form film editing method using the invention;

FIG. 2 shows a preferred form data format conversion in accordance with the invention;

FIG. 3 illustrates an exact match comparison;

FIG. 4 illustrates a similar events comparison; and

FIG. 5 illustrates a tag-checking routine.

### DETAILED DESCRIPTION OF PREFERRED FORMS

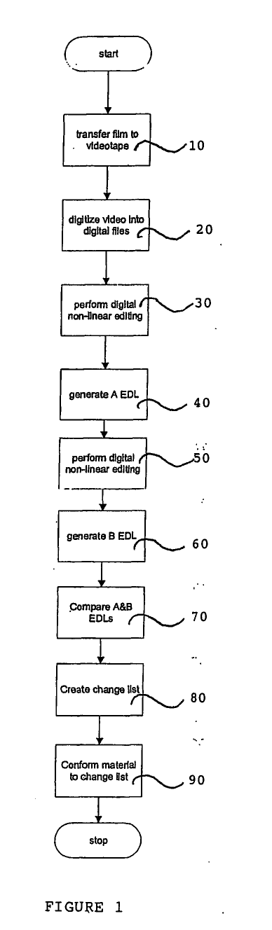

As shown in FIG. 1, a film involving a series of shots or sequences is typically shot on a 35 mm or 16 mm film or video tape. The film could be transferred 10 to a video tape or further video tape in order to facilitate “off-line” editing. Online video editing occurs when the original source material is used in future editing sessions. Offline editing occurs when an inexpensive and expendable copy of the original material is used instead of the original material. The completed film is usually made from the original material and so offline editing is generally followed by online editing.

Rather than working with the original film initially, a video tape transfer is made from the camera original. The video tape with time code can be edited using video editing equipment and the result is an edited video tape. If the relationship between the time code on the video tape and the edge numbers on the original film is known, a list of edge numbers can be generated for assistance in matching the negative to the edited video.

It is desirable to transfer the video into digital files and edit these digital files using computer software rather than editing the video tape. This method is known as “digital non-linear editing”. To facilitate such editing, the video is first digitised 20 into digital files and stored in computer memory. Digital non-linear editing is then performed 30 on these digital files.

One or more edit decision lists (EDLs) are then generated from the digital files. EDLs are generally text files which represent a record of what exactly has been edited on a linear video tape editing system. EDLs were originally designed to be used by the tape editing systems to recreate the same edits. EDLs effectively contain all the instructions for editing a film.

Most EDLs are ASCII files and can be generated in one or more formats, for example CMX, or GBB. The invention is described with reference to the standard CMX 3600 EDL output, although it will be appreciated that the invention could be applied to any suitable output.

In one form an “A” EDL could be generated 40 followed by the step of performing 50 digital non-linear editing. A further “B” EDL could then be generated 60.

The invention provides a method of comparing 70 up to 36 A-side and B-side EDLs. Full details of the comparison process are described below.

Once the comparison process is finished, a change list is created 80 specifying a list of completely new material, and a list of changes made to old material. Using the change list, material including the video tape, film, data or sound track elements are conformed 90.

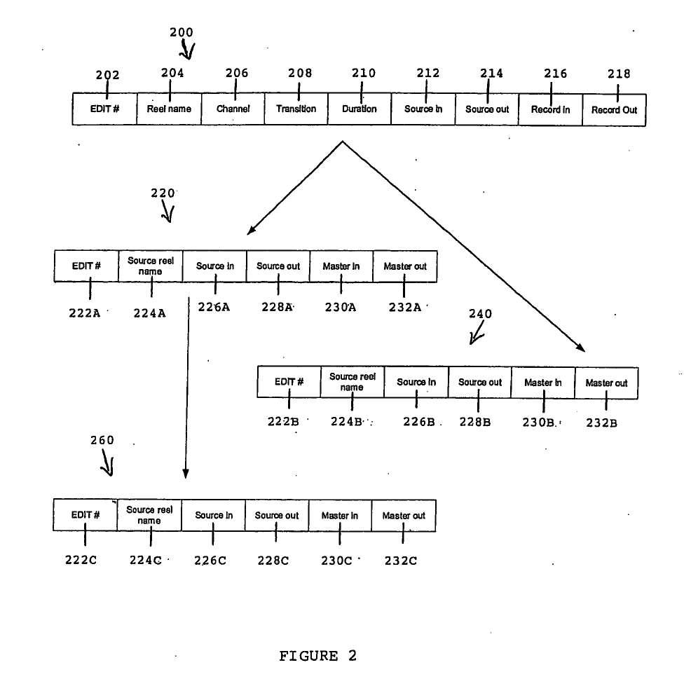

The invention imports edit decision list (EDL) data and translates this data into further data fields for subsequent use. FIG. 2 illustrates a preferred form translation process. A typical EDL record in CMX format is indicated at 200. As described above, an EDL is a list of “events” that include the source location, and where to record it. In addition, the EDL includes information about transitions, for example cuts, dissolves or wipes, transition durations and so on.

An edit decision list will usually contain a series of such individual records maintained in computer memory. Each record could include for example an edit number 202, a source reel name 204, the channel or channels to record 206, the transition 208 for example cut, dissolve and so on, a transition duration 210 if applicable, source in time code 212, source out time code 214, record in 216 and record out 218.

Each EDL file comprising a series of such records is parsed into the correct fields in an A-side 220 representing previous or earlier edits of the film or video and a B-side 240 representing the current edit. The EDL is a text string that requires parsing into the correct data fields. The A-side for example could contain edit number 222A, source reel name 224A, source in 226A, source out 228A, master in 230A and master out 232A. The B-side could contain corresponding fields for example, edit number 222B, source reel name 224B, source in 226B, source out 228B, master in 230B and master out 232B.

Time code fields are preferably converted into frames using a calculation field, for example as follows:
(((TextToNum(Middle([AEDL]Source In, 1,2))*60*60*[Global]Frm Rate)+(TextToNum(Middle([AEDL]Source In,4,2))*60*[Global]Frm Rate)+(TextToNum(Middle([AEDL]Source In,7,2))*[Global]Frm Rate)+(TextToNum(Middle([AEDL]Source In, 10,2)))))

The variable [Global]Form Rate represents the project-shooting rate of either 24, 25 or 30 frames per second (FPS). All calculations are preferably made in frames, as time code is not an easily divisible format. It is preferable that, following the calculations, the time code is then inserted into the output of the system. For the purposes of comparison there are two sides to the importing process. The invention preferably has the ability to import up to 36 lists in both sides.

After importation, cleaning procedures are applied to the EDL to clean the list of unwanted or irrelevant material. For example, black introduced at the editing stage will apply random values to the list and lead to incorrect output. As black is of no interest for comparison purposes, it is eliminated.

The A-side is preferably exported to comparison file 260 to facilitate comparison between A and B sides. The comparison file could comprise edit number 222C, source reel name 224C, source in 226C, source out 228C, master in 230C and master out 232C. In one preferred form the A-side 220 fields are simply copied to a comparison file 260 with a direct mapping of fields between the two files.

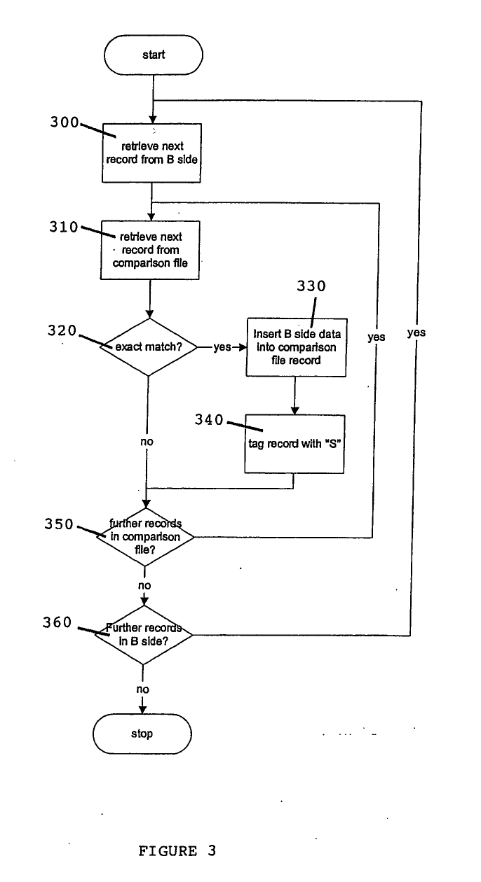

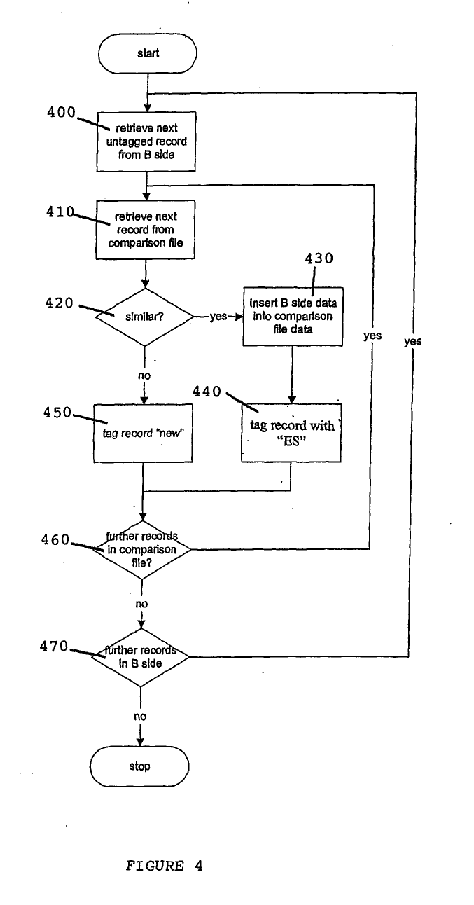

The next step is to categorise the edits by determining which of the edits are identical or the same, which edits are similar but with differences, and which edits represent new material. The categorising is preferably implemented by a category assignor that is configured to assign a category to one or more edits. The category assignor is preferably a computer-implemented data matching component, the function of which is described below with reference to FIGS. 3 and 4. A comparator is a similarly implemented computer routine to compare edits prior to assigning categories.

Referring to FIG. 3, individual records are retrieved 300 from the B-side EDL, or where there is more than one B-side, the first B-side. Individual records are retrieved 310 from the comparison file. The records are compared 320 for an exact match.

A typical comparison could be comparing a concatenated field which contains project ID, source reel, clip name, source in and source out. On finding an exact match, the B-side data is inserted 330 into the retrieved comparison file record and the retrieved record is tagged 340 with an indicator representing an exact match. A typical indicator could be the letter “s” representing shots in the film that have not changed. The amended comparison file record is then stored in the comparison file.

If there are further records 350 in the comparison file and/or further records 360 in the B-side, these further records are retrieved and compared.

Referring to FIG. 4, the next step is to check for similar events. These are events which are similar but to which edits have been made.

Records which have not already been tagged by the method described above with reference to FIG. 3 are retrieved 400 from the B-side. Individual records are retrieved 410 from the comparison file.

The records are tested for similarity. One similarity test could comprise testing for source reel and frame range in the source in and a frame range in the source out. If the records are held to be similar, the B-side data is inserted 430 into the comparison file record and the record is tagged 440 with an indicator of similarity. A typical indicator could comprise the text string “ES” for “edit slate”.

If the records are not similar, the comparison file record is tagged 450 with an indicator representing new material for example the text string “new”. Further records 460 are retrieved from the comparison file and further records 470 are retrieved from the B-side.

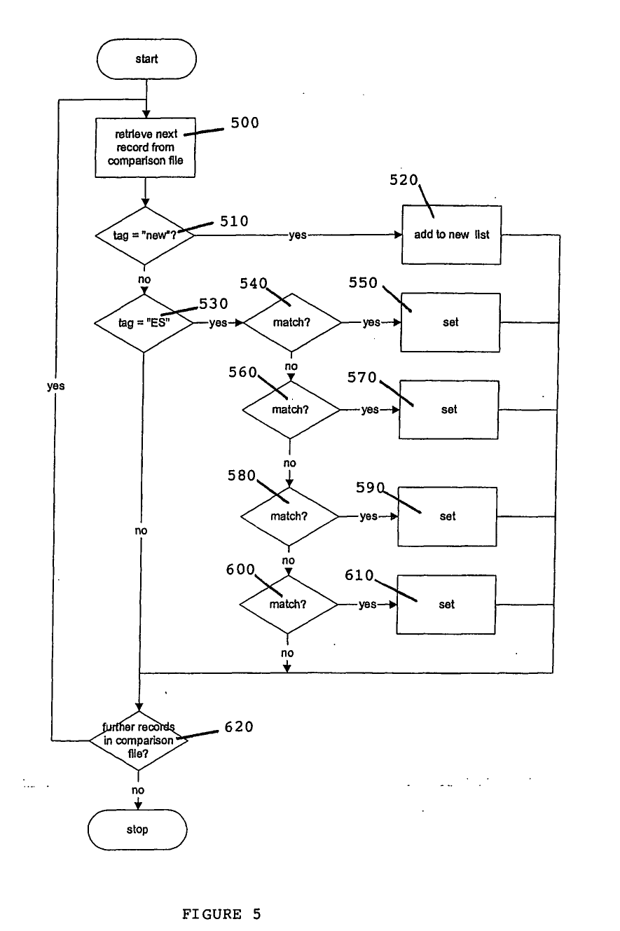

The resulting comparison file will comprise a series of records, each of which is tagged with “S”, “ES” or “NEW”. The comparison file is then used to generate the change list. The generation is preferably performed by a generator that is a computer-implemented program configured to generate at least one change list based on the comparisons made by the comparator. Preferred form functions of the generator are described below with reference to FIG. 5.

Referring to FIG. 5, an individual record is retrieved 500 from the comparison file.

If the file is tagged 510 as being new (NEW), this record information is added to the new list 520 resulting in a list of completely new material.

If the retrieved record is not tagged new but is tagged 530 as being similar (ES), the “S” further tests are then performed.

If 540 A-side source in is less than or equal to B-side source in and A-side source out is less than or equal to B-side source out, then the following action 550 is taken:
set A Side to A side Master in+(B side Source in−A side Source in)
set B Frames to B Side Master In
Set Duration of B Side to B Side MASTER (BSideSource Out−A Side Source Out)
Set Duration of A Side to A Side Master duration−(B side Source Out−A Side Source Out)

Alternatively, if 560 A-side source in is less than or equal to B-side source in and A-side source out is greater than or equal to B-side source out, then the following action 570 is taken:
set A Side to A Side Master in+(B Side Source in−A Side Source in)
set B side to B Side Master in
Set Duration of B side to B Side Master Duration
Set Duration of A side to A Side Master Duration

If 580 A-side source in is greater than or equal to B-side source in and A-side source out is less than or equal to B-side source out, then the following action 590 is taken:
set A Side to A side Master in
set B side to B side Master in+(A Side source in−B Side Source in)
Set Duration of B Side to B side Master Duration
Set Duration of A Side to A side Master Duration

If 600 A-side source in is greater than or equal to B-side source in and A-side source out is greater than or equal to B-side source out, then the following action 610 is taken:
set A Side to A Side Master In
set B Side to B Side Master in+A Side Source in−B Side Source in)
Set Duration of B Side to A Side Master duration−(A Side Source Out−B Side Source Out)
Set Duration of A Side to A Side Master Duration−(A Side Source Out−B Side Source Out)

Further records 620 if any are retrieved from the comparison file.

After these tests are concluded, all the frames calculations are converted back to time code at the correct frame rate. Two lists are generated representing a list of completely new material, and a list of edited material. The list containing edited material can then be used for further processing, for example the updating of sound track elements or data information such as ADR or sound effects spotting lists.

The foregoing describes the invention including preferred forms thereof. Alterations and modifications as will be obvious to those skilled in the art are intended to be incorporated within the scope hereof, as defined by the accompanying claims.

1. A method of film data comparison comprising the steps of:
storing in computer memory two or more data files representing edit decision lists;
comparing individual edits within the data files;
categorizing edits within the data files; and
generating at least one change list based on the comparisons.

2. A method of film data comparison as claimed in claim 1 further comprising the steps of:
exporting at least one data file to a comparison file; and
comparing the comparison file with the remaining one or more data files.

3. A method of film data comparison as claimed in claim 1 wherein the step of categorizing the edits within the data files comprises the step of assigning a category to each edit of identical (S), similar (ES) or new (NEW).

4. A method of film data comparison as claimed in claim 3 comprising the step of assigning the category S to an edit based on string comparison of concatenated data fields.

5. A method of film data comparison as claimed in claim 3 comprising the step of assigning the category ES to an edit based on comparisons of data field values.

6. A method of film data comparison as claimed in claim 3 further comprising the steps of:
assigning the category S to selected edits;
assigning the category ES to selected edits not already categorised S; and
assigning the category NEW to all edits not already categorised S or ES.

7. A comparison file generated by the method of claim 1.

8. A change list generated by the method of claim 1.

9. A film data comparison system comprising:
a comparator configured to compare individual edits Within data files representing edit decision lists;
a category assignor configured to assign a category to one or more edits within the data files; and
a generator configured to generate at least one change list based on the comparisons made by the comparator.
